(19) United States
(12) Patent Application Publication
(10) Pub. No.: US 2017/0230810 A1
(43) Pub. Date: Aug. 10, 2017

(54) ESTABLISHING AND COMMUNICATING DATA OVER A WIRELESS CONNECTION

(71) Applicant: Qualcomm Technologies International, Ltd., Cambridge (GB)

(72) Inventor: Raja Banerjea, San Jose, CA (US)

(21) Appl. No.: 15/017,206

(22) Filed: Feb. 5, 2016

(51) Int. Cl. H04W 8/00; H04W 4/00; H04W 76/02

(52) U.S. Cl. CPC H04W 8/005; H04W 76/023; H04W 4/008; H04W 88/06

(57) ABSTRACT

A method of operating a wireless device in accordance with multiple wireless technologies. The wireless device transmits an advertising message to a target device using a first wireless technology and establishes a wireless connection with the target device based at least in part on the advertising message. Upon establishing the wireless connection, the wireless device may transmit one or more data messages to the target device using a second wireless technology that provides higher bitrates than the first wireless technology.

### TECHNICAL FIELD

This disclosure relates to establishing and communicating data over a wireless connection. In particular, aspects of the disclosure relate to establishing a wireless connection using a first Bluetooth technology and transmitting data messages over the connection using a second Bluetooth technology.

### BACKGROUND OF RELATED ART

An increasing number of devices are capable of communicating messages according to at least one Bluetooth technology. One example of a Bluetooth technology is the protocol defined for providing Bluetooth basic data rate (BR or BDR)/enhanced data rate (EDR) communications. Bluetooth BR/EDR communications may also be referred to as ‘Classical Bluetooth’. A further example of a Bluetooth technology is the protocol defined for providing Bluetooth Low Energy (BLE) communications, which may also be referred to as Bluetooth Smart. A device may be referred to as being capable, or configured, to operate according to Bluetooth BR/EDR and/or BLE if it meets the appropriate requirements specified in the Bluetooth specifications managed by the Bluetooth special interest group (SIG). Version 4.2 of the Bluetooth specification states, for example, that BLE devices should have a maximum transmission power of 10 dBm (10 mW).

As well as the requirements of the Bluetooth specifications, Bluetooth-equipped devices may be subject to different regulatory requirements across different geographical jurisdictions. For example the US, Europe, China, Japan, Korea and Taiwan each have their own regulatory bodies that specify their own regulations. These regulations may place constraints on the operational behavior of the devices, such as specifying maximum transmission power levels. These requirements may additionally vary for different Bluetooth technologies. For example, the European Telecommunications Standard Institute (ETSI) currently classifies Classical Bluetooth devices as frequency hopping equipment and states that such devices should have a maximum RF transmission power of less than or equal to 20 dBm. In contrast, the ETSI does not currently classify a BLE device as frequency hopping equipment. This means that a BLE device wishing to satisfy the requirements of the ETSI should have a maximum RF transmission power of less than or equal to 10 dBm (required by version 4.2 of the Bluetooth standard) and have a maximum power spectral density of less than 10 mW/MHz (specified by the ETSI). These requirements, coupled with the conventional maximum bit rate for BLE of 1 Mbps or 2 Mbps, may limit the range of packets that can be communicated between devices using BLE.

Other regulatory bodies (such as the Federal Communications Commission (FCC)) do not place constraints on the maximum transmission power of BLE or BR/EDR devices. Because of this, the Bluetooth SIG considered removing the 10 dBm transmission power limit for BLE devices and instead allowing vendors/manufacturers to acquire the regulatory approval they require based on the regions in which they sell and/or manufacture their products. However, this would require each vendor to make and maintain their own inventory of region-based requirements, or for example a device (e.g. a mobile phone) to first identify the locality it is currently operating in through Cellular or GPS and then configuring the Bluetooth system for transmit power in that region.

It would be desirable for there to be greater flexibility in communication between devices that meet multiple regulatory requirements.

### SUMMARY

A method of operating a wireless device in accordance with multiple wireless technologies is disclosed. The wireless device transmits an advertising message to a target device using a first wireless technology and establishes a wireless connection with the target device based at least in part on the advertising message. Upon establishing the wireless connection, the wireless device may transmit one or more data messages to the target device using a second wireless technology that provides higher bitrates than the first wireless technology.

In other aspects, a wireless device is disclosed. The wireless device may include one or more processors and a memory storing insturctions that, when executed by the one or more processors, cause the wireless device to transmit an advertising message to a target device using a first wireless technology, establish a wireless connection with the target device based at least in part on the advertising message, and upon establishing the wireless connection, transmit one or more data messages to the target device using a second wireless technology that provides higher bitrates than the first wireless technology.

In other aspects, a non-transitory computer readable medium is disclosed. The non-transitory computer readable medium may be configured to store instructions that, when executed by one or more processors of a wireless device, cause the wireless device to transmit an advertising message to a target device using a first wireless technology, establish a wireless connection with the target device based at least in part on the advertising message, and upon establishing the wireless connection, transmit one or more data messages to the target device using a second wireless technology that provides higher bitrates than the first wireless technology.

### BRIEF DESCRIPTION OF THE DRAWINGS

The example embodiments will now be described by way of example with reference to the accompanying drawings. In the drawings:

FIG. 1 shows an example of a communication network.

FIG. 2 shows a schematic illustration of the architecture of a communication device.

FIG. 3 shows a schematic illustration of the protocol layers of a Bluetooth stack.

FIG. 4 shows a flow-chart illustrating the connection and transmission of data over a wireless communication connection.

FIG. 5 shows a schematic illustration of a sequence of messages transmitted between communication devices to establish a communication connection.

Where appropriate, like reference numerals have been used in the following description to denote like components.

### DETAILED DESCRIPTION

The examples described herein are directed to enabling a communication device to establish a Bluetooth connection with one or more other devices using a first Bluetooth technology by transmitting Bluetooth advertising messages at a first bitrate and then, once a connection has been established, transmitting Bluetooth data messages using a second Bluetooth technology at a second bitrate greater than the first bitrate. This allows a communications device to establish a connection at a lower transmit power and then subsequently transmit data messages at a higher transmit power once the connection has been established. In one example the first Bluetooth technology is subject to a defined maximum physical layer bitrate that is less than the defined maximum physical layer bitrate of the second Bluetooth technology. For example the defined maximum physical layer bitrate of the first Bluetooth technology may be less than 1 Mbps. Thus the device may establish the connection by transmitting an advertising message at a physical layer bitrate that is lower than the conventional bitrate of 1 Mbps defined by BLE. The first Bluetooth technology may define a maximum bitrate of less than or equal to 500 kbps (kilo-bits per second). The first Bluetooth technology may be referred to as Bluetooth Long Range (BLR). This lower bitrate may result in devices being able to increase their range over the advertising channel compared to conventional BLE devices whilst maintaining worldwide regulatory compliance. In other words, the device may be able to increase the range within which it can establish connections with other devices compared to devices that use BLE or BR/EDR to establish a connection. The lower raw bitrate means the device may be able to increase its range whilst maintaining its transmission power levels below the maximum levels specified by each regulatory body (for example the ETSI, FCC etc.).

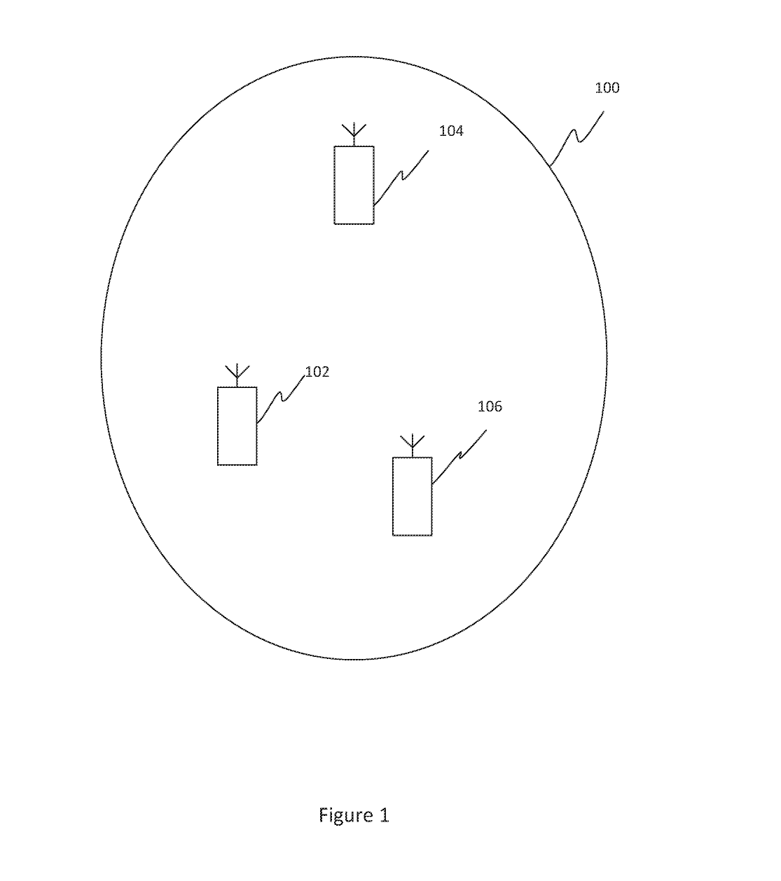

FIG. 1 shows an example of a network 100. The network comprises communication devices 102, 104 and 106. Each device comprises a transceiver for communicating messages over the network. Each device is capable of communicating according to one or more Bluetooth technologies. In this particular example, each of devices 102, 104 and 106 is configured to be able to communicate according to Bluetooth Low Energy technology and Bluetooth Long Range technology. Devices 102 and 104 can additionally communicate according to the ‘Classical’ Bluetooth technology (Bluetooth BR/EDR). Devices 102 and 104 may therefore be referred to as “tri-mode” devices. Device 106 that supports the BLE and BLR technologies may be referred to as a dual mode device. The devices may comprise one radio per supported Bluetooth technology, e.g. device 106 may have a radio dedicated to communicating messages according to BLR and one radio dedicated to communicating messages according to BLE. Alternatively the devices may have a single radio configured to enable communication according to a combination of technologies (e.g. a single radio for communicating messages according to BLE, BLR and BR/EDR, or a single radio for communicating messages according to BLE and BLR etc.).

Each technology may be specified by a respective Bluetooth standard. A ‘technology’ may also be referred to as a Bluetooth system. Each technology may be capable of supporting a data session, or communication connection, between connected devices. Each Bluetooth technology may define a respective maximum physical layer data rate, or bitrate, that a device operating according to that technology can transmit at. BLR may be characterized by, potentially among other things, having a defined maximum physical bitrate of 500 kbps. A device operating according to BLR may transmit messages at one of a plurality of physical data rates specified, or defined, by that technology. These specified data rates may be 125 kbps and 500 kbps. BLE may define a different maximum bitrate to that of BLR. BLE may specify a maximum physical bitrate of 1 Mbps, or 2 Mbps. Classical Bluetooth may define a maximum bitrate of 1 Mbps for basic rate (BR), and 2 Mbps or 3 Mbps for enhanced rate (ER). The physical bitrate may be referred to as a “raw” bitrate in that it refers to the number of physically transmitted bits per second over a communication link. This may be in contrast to, for example, the data throughput, which may refer to the rate at which data is communicated between two devices over a network (and thus depends on the amount of data loss, errors in received packets etc.). The raw bitrate may also be distinguished over the net bitrate (or information rate; effective data rate etc.), which may refer to the data rate that excludes the overheads of the packets, header bits etc.

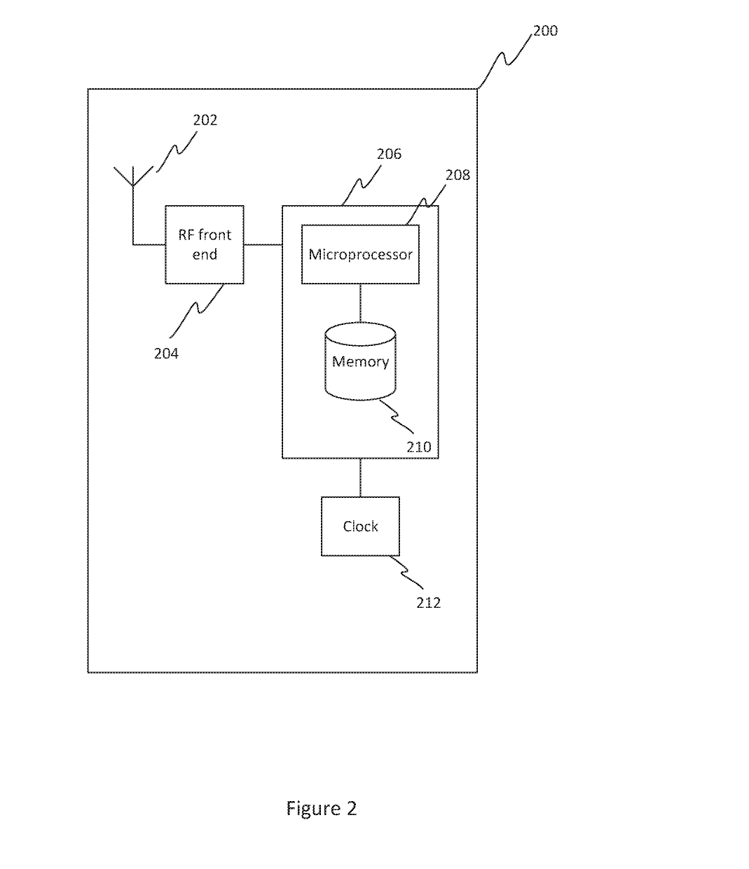

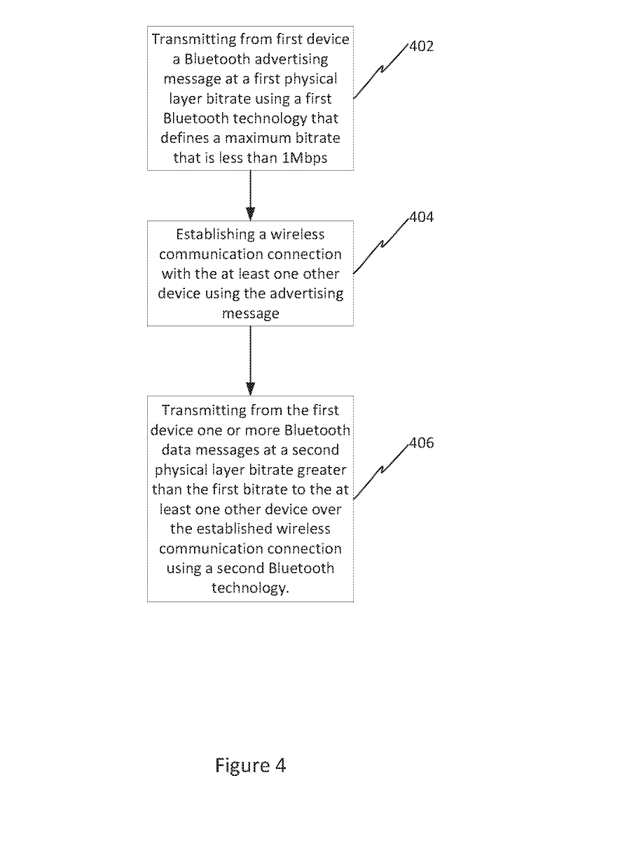

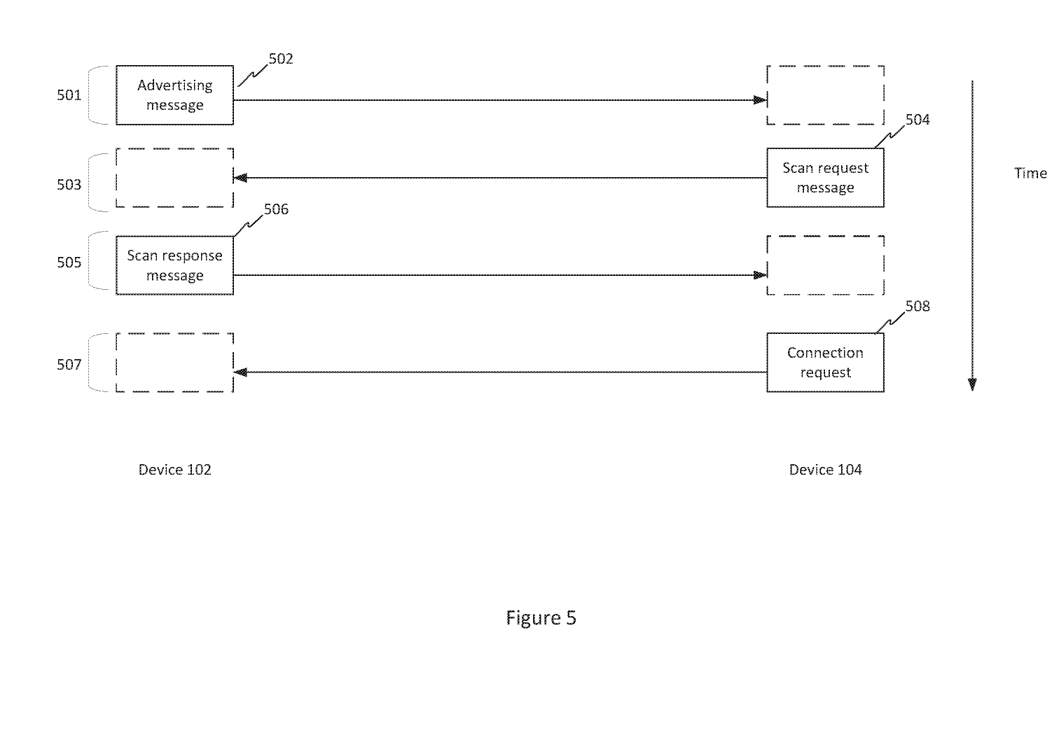

The architecture of one of devices 102, 104 and 106 is shown in FIG. 2. The device 200 comprises an antenna 202, a radio frequency (RF) front end 204 and a baseband processor 206. The baseband processor comprises a microprocessor 208 and a non-volatile memory 210. The non-volatile memory stores in non-transitory form computer program code that is executable by the microprocessor to cause the baseband processor to implement the communications protocol(s) of the network and the methods described herein with reference to FIGS. 4 and 5.

In order to transmit messages across the network 100 the processor 208 can drive the RF front end 204, which in turn causes the antenna 202 to emit suitable RF signals. Messages received at the antenna from the network 100 can be pre-processed (e.g. by pre-filtering and amplification) by the RF front end. The RF front end can present corresponding signals to the processor 208 for decoding. The processor may operate to drive the RF front end and/or decode signals received from the RF front end in various ways in dependence on the Bluetooth protocol used to transmit the message and the type of Bluetooth channel over which the message was communicated. This will be described in more detail below.

The device 200 additionally comprises a clock 212. The clock may be used by the microprocessor to set the bitrate for messages to be transmitted from the device.

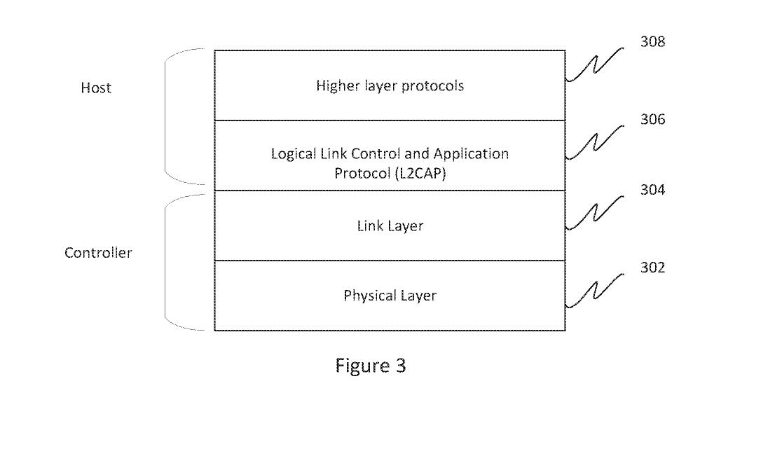

The microprocessor can cause the device to communicate according to a supported Bluetooth technology by implementing an associated Bluetooth protocol stack for that technology. A schematic illustration of a Bluetooth protocol stack is shown in FIG. 3. The stack comprises a physical layer 302, a link layer 304, and logical link control and application protocol (L2CAP) layer 306. It may additionally define one or more higher layers, indicated generally at 308. The higher layers may differ for the different Bluetooth technologies. For example, the upper layers for BLE may comprise one or more of an Attribute Protocol layer, a Security Manager Protocol layer, a Generic Attribute Profile (GATT) layer and a Generic Access Profile (GAP) layer. For classical Bluetooth, the upper protocol layers may comprise an RFCOMM protocol layer and a serial port profile (SPP) layer.

The link layer and the physical layer form the Controller. The controller may be implemented as a system on chip (SoC) with an integrated radio for transmitting and receiving messages. The upper layer protocols (in this example the L2CAP; SMP; Attribute protocol; GATT and GAP) form the Host. The host may run on an application processor. The host and controller may be separated by a host-controller interface (HCl).

A description of the protocol stack for each of the BLR, BLE and BR/EDR technologies is now provided.

### Bluetooth Long Range

The physical layer 302 controls the characteristics of the signals transmitted by the antenna. BLR may operate in the 2.4 GHz ISM band and define a plurality of radio frequency (RF) channels. BLR may define two types of RF channels: advertising channels and data channels. Advertising channels may be used for discovering other devices within range, for establishing a connection or for broadcast transmission. BLR may define a predetermined number of advertising channels and data channels. The number of advertising channels specified by BLR may be three, for example. Data channels may be used to transmit data messages between connected devices. Data messages may be communicated bi-directionally over a data channel. That is, two devices may bi-directionally communicate data messages over a data channel supported by BLR. The device may communicate data messages over the data channels using a frequency-hopping scheme in which the device communicates over different RF data channels by ‘hopping’ from one RF channel to another according to a hopping sequence.

The link layer 304 may be responsible for creation and modification of logical links between devices. It may also be responsible for managing the parameters associated with physical links between devices. The link layer may for example specify the physical bitrate to be employed by the device when transmitting messages according to BLR. In other words the link layer may be responsible for selecting a bitrate from a plurality of bitrates defined by BLR. The link layer may for example specify that the device communicates messages at a bitrate of 125 kbps or 500 kbps. As discussed above, BLR may define a maximum physical bitrate of 500 kbps.

The link layer may additionally define different states for a device, such as a standby state, an advertising state, a scanning state, an initiating state and a connection state. When a device is in the standby state the link layer does not transmit or receive packets. When a device is in the advertising state the link layer may transmit advertising packets. The devices may be configured so as to transmit a response packet in response to receiving an advertising packet. Thus a device may additionally listen for responses from other devices triggered by the advertising packets when in the advertising state. When a device is in the scanning state the link layer may listen for advertising packets from devices that are advertising. When a device is in the initiating state the link layer may listen for advertising packets from a specific device/devices and respond to those packets to initiate a connection with a third device. When the device is in a connection state it can communicate data messages over a data channel. The device may be in a connection state once it has established a communication connection with one or more other devices.

### Bluetooth Low Energy

BLE similarly operates in the 2.4 GHz ISM band. It defines 40 RF channels and two types of RF channel: advertising and data channels. BLE defines three advertising channels and 37 data channels. The characteristics of these channels may be similar to those described above for BLR and so will not be repeated here. Connected devices (i.e. devices that have established a communication connection) may form a piconet comprising a single master and one or more slaves. Each device in the piconet follows the same frequency hopping pattern in accordance with the master's clock.

The link layer may operate in a similar manner to the link layer described above for BLR.

The L2CAP layer 306 may be used in BLE to multiplex the data of the higher layer protocols on top of a link layer connection. It permits higher layer protocols and applications to transmit and receive upper layer data packets.

### Classical Bluetooth

The physical layer for Bluetooth BR/EDR similarly operates in the ISM band at 2.4 GHz. Connected devices form a piconet comprising a single master and one or more slaves. Each device in the piconet follows the same frequency hopping pattern in accordance with the master's clock. The pattern may be a pseudo-random ordering of the 79 RF channels. The hopping pattern can be adapted to exclude certain RF channels if these are known to interfere with neighboring devices.

The maximum physical bitrate for BR is 1 Mbps. The maximum physical bitrate for EDR is 2 Mbps or 3 Mbps. These bitrates may again be referred to as ‘raw’ bitrates.

The link manager is responsible for the creation, modification and release of logical links. It may also be responsible for the update of parameters related to physical links between devices. The link manager of one device communicates with the link manager of a different device via a link manager protocol (LMP). The link manager may control the creation of logical links between devices. It may further control link parameters such as enabling encryption or the adjustment of quality of service (QoS) of a logical link between devices. The protocol may additionally comprise a link controller (not shown) that controls the encoding and decoding of Bluetooth packets from the data payload. The link controller may additionally provide asynchronous connection links (ACL) and/or synchronous connection-oriented (SCO) links between devices. These links may be used to communicate data packets between two connected devices (e.g. a master and a slave).

The L2CAP layer 322 for BR/BDR may perform similar functions as the corresponding L2CAP layer of the BLE protocol stack.

It will be appreciated that the protocol stacks for BLE and BR/EDR described above are examples and a device may support one or more of the BLR, BLE and BR/EDR technologies without having to implement each layer and/or feature of the above-described stacks. Further, a device may comprise additional protocol layers or applications not shown in the above stacks. These protocol layers may for example reside above the protocol stacks shown above.

As mentioned above, in order to communicate over a network, the devices transmit messages to each other. These messages may be advertising messages (e.g. messages sent over an advertising channel in order to try and establish a connection between two devices), or data messages (e.g. messages sent over a data channel between two connected devices). The messages may be in the form of packets with a packet structure. This packet structure may be defined by the Bluetooth technology according to which the messages are communicated.

The operation of device 102 in establishing and communicating data over a wireless communication connection will now be described with reference to FIG. 4. In this example, the device 102 establishes a connection with device 104.

At step 402, device 102 transmits a Bluetooth advertising message at a first physical bitrate using a first Bluetooth technology that defines a maximum bitrate that is less than 1 Mbps. The message may for example be communicated according to BLR.

The advertising message may be communicated over an advertising channel. The advertising channel may refer to one of the dedicated RF channels used for advertising messages as described above. The device 102 may be in an advertising state when it communicates the advertising message. The device 104 may be in a scanning state in which it listens on the advertising channels for advertising messages. Alternatively it may be in an initiating state. The device may be configured not to use the or each advertising channel for a data connection. The or each advertising channel may be a physical or logical channel, for example a specific frequency channel.

Because the BLR technology used to communicate the advertising message has a maximum bitrate of less than 1 Mbps, the bitrate at which the advertising message is transmitted from device 102 is lower than the conventional bitrate for BLE of 1 Mbps. The maximum bitrate specified by BLR may be less than half of 1 Mbps. It may for example be 500 kbps, or 125 kbps. The device may be capable of selecting one of a plurality of raw bitrates defined by BLR (e.g. 125 kbps and 500 kbps), each lower than the conventional bitrate for BLE. The bitrate may be specified by the link layer of the protocol stack being implemented by the device.

It has been found that by communicating advertising messages using BLR, the range of the advertising messages can be extended compared to advertising messages transmitted according to BLE. This is due to the increased receiver sensitivity at the lower bitrates made possible by BLR.

The sensitivity level of a receiver may be defined as the input level for which a predetermined raw bit error rate (BER) (e.g. of 0.1%) is met. Bluetooth devices may have to have a minimum receiver sensitivity that they are to satisfy for Bluetooth transmitters. This minimum receiver sensitivity may be specified by the Bluetooth specifications. By improving the receiver's sensitivity, the range of the advertising messages can be increased. The receiver sensitivity is a function of the transmitted raw bitrate (potentially amongst other factors). It has been calculated that the receiver sensitivity for data transmitted at a raw bitrate of 125 kbps may be improved by up to 12 dB than for data transmitted at a raw bitrate of 1 Mbps, and the receiver sensitivity for data transmitted at a raw bitrate of 500 kbps may be improved by up to 5 dB than for data transmitted at a raw bitrate of 1 Mbps. It has therefore been found that using BLR to transmit the advertising messages at a bitrate of less than 1 Mbps may improve the receiver sensitivity of receiving devices compared to transmitting advertising messages using BLE.

As an illustration of how improving the receiver sensitivity may improve the range of the advertising messages, consider the following example calculation of a link budget that calculates the received power of a signal according to the equation:

received power (dBm)=transmitted power (dBm)−losses (dB) (1)

Here, received power is the power of the received signal at the receiver device, transmitted power is the power of the transmitted signal from the transmitting device, and losses represent the losses experienced by the signal as it propagates from the transmitting device to the receiving device (e.g. due to interference, environmental effects, etc.). Consider an example in which the receiver sensitivity of device 104 for Bluetooth messages transmitted at a rate of 1 Mbps is −90 dBm, the transmit power from device 102 is 10 dBm (in order to comply with the Bluetooth standards and to ensure worldwide regulatory compliance), and the path losses between device 102 and 104 are 105 dB. In this case an advertising message transmitted using BLE at the conventional bitrate of 1 Mbps could not be used to establish a connection between devices 102 and 104 because the received power as calculated according to equation (1) would be equal to −95 dBm, which is lower than the receiver sensitivity of device 104. However, if device 102 were to transmit the advertising message at a reduced bitrate of 125 kbps, the receiver sensitivity of device may be improved by 12 dBm to be −102 dBm. Under this scenario an advertising message transmitted at the same power of 10 dBm could be used to establish a connection between devices 102 and 104 because the received power of the message as calculated according to equation (1) would be higher than the receiver sensitivity of the device.

Thus communicating Bluetooth advertising messages at a rate lower than the conventional bitrate of 1 Mbps may increase the range of advertising messages and hence enable advertising messages to be received by devices at a greater distance from the transmitting device. Advantageously, it enables the range of the advertising messages to be increased without increasing the transmit power of the transmitting device. Thus the device may be able to increase its range whilst continuing to maintain worldwide regulatory compliance. For example, if device 102 transmitted the advertising messages at a power density of 10 mW/MHz (in accordance with ETSI requirements) at a rate of 125 kbps (i.e. at a power level of 1.25 mW), the transmission power in dBm as calculated according to the equation Power (dBm)=10 log₁₀ (power (mW)) would be 0.97 dBm, well below the level required for worldwide regulatory compliance. It further enables a receiver device to increase its sensitivity without any modifications needing to be made to the receiver circuitry.

At step 404, a wireless communication connection is established between devices 102 and 104 using the communicated advertising message. When a communication connection is established between devices 102 and 104, the devices may be in a ‘connected state’, or ‘connection state’. That is, a logical link may exist between the devices (the logical link may exist with respect to a specific physical link between the devices). When in the connection state one of the devices (e.g. device 102) may be the master device and the other device (e.g. device 104) may be the slave device. The devices may form a piconet once a communication connection has been established between them. A frequency hopping pattern for communicating over the piconet may also have been established as part of the connection establishment procedure.

An example of how the advertising message can be used to establish a connection is described with reference to FIG. 5. At step 501, device 102 transmits an advertising message 502 to device 104. Device 104 is initially in a scanning state in which it listens for advertising messages. At step 503 device 104 responds to receiving the advertising message by transmitting a scan request message 504 to device 102. The device 504 ascertains the ID and/or address of device 102 from information contained in the advertising message. The scan request message may contain requests for additional information about the advertiser (device 102). It may be transmitted according to the same Bluetooth technology (e.g. BLR) as the advertising message 502. The message 504 may also be sent over an advertising channel. The message may be sent over the same advertising channel as the advertising message. In response to receiving the scan request message, at step 505 the device 102 transmits a scan response message 506 to the device 104. Message 506 may also be transmitted according to BLR. In reply, at step 508 the device 104 transmits a connection request message 508 to the device 102 to establish the connection. In response to receiving the connection request message 508, the device 102 may transition from the advertising state to the connection state. Each of messages 502, 504, 506 and 508 may be transmitted over an advertising channel. Each may be communicated according to the same Bluetooth technology.

In an alternative example, the device 104 may respond directly to the advertising message 502 by sending a connection request message (i.e. without first sending a scan request message). Device 104 may do this if it is in an initiator state, for example.

Steps 504 to 508 may be summarized as establishing a communication connection, or communication protocol, between the devices. Thus a device may be configured to establish a communication connection with another device in response to receiving an advertising message from that device. As part of establishing the communication connection, communication parameters that are required to support the data communication connection between the devices may be exchanged between the devices. Thus a device may be configured to exchange communication parameters in response to receiving an advertising message. A device may exchange communication parameters by requesting parameters, providing parameters, or a combination thereof. An advertising message may therefore be characterized as a message that causes or enables a device that receives it to establish a communication connection, and/or as a message that causes a device that receives it to exchange communication parameters required for supporting a communication connection with the device that transmitted it.

The parameters exchanged between devices 102 and 104 as part of the connection establishment procedure may include parameters that indicate the frequency hopping pattern to be used by the devices once they are connected. The advertising message may also comprise a device ID and/or address for device 102 and a payload indicating device 102's ability to support a communication connection.

Although not shown in FIG. 5, the device 102 may be configured to transmit the advertising message periodically. It may do this when the device is in an advertising state. The advertising message may contain a device ID for device 102. It may additionally comprise information that indicates the device's ability to support a communication connection. The advertising messages may be communicated as part of an advertising event. Steps 504 to 508 may be one example of an advertising event.

Once a connection between devices 102 and 104 has been established, then at step 406 device 102 transmits one or more Bluetooth data messages at a second physical layer bitrate greater than the first physical layer bitrate to device 104 over the established wireless communication connection using a second Bluetooth technology. Thus the physical bitrate used to communicate the data messages is greater than the bitrate used to communicate the advertising messages. The communication device may be configured to switch from the first Bluetooth technology to the second Bluetooth technology in response to detecting that a connection has been established.

The second Bluetooth technology may define a maximum physical bitrate that is greater than the maximum physical bitrate of the first Bluetooth technology. The second Bluetooth technology could for example be BLE or BR/EDR. Thus the device could transmit the data messages at a bitrate that is greater than the maximum bitrate defined by the first Bluetooth technology.

In other words device 102 can use a lower bitrate to transmit the advertising packets, and then switch to use a higher bitrate to transmit data messages once a bi-directional communication connection has been established. Rather than using the first Bluetooth technology to also transfer data messages over the established connection, it has been realised that by instead switching to a second Bluetooth technology once a connection has been established that is subject to a greater defined maximum bitrate than the first Bluetooth technology, the device can increase the range of its advertising packets in order to establish connections with other devices whilst also benefiting from an increased bitrate for data transfer for improved performance. The device may also be configured to increase its transmission power when it switches to communicating data messages compared to the transmission power used to transmit the advertising messages.

The device may be configured to be capable of transmitting the data messages using: (i) BLE; (ii) BR/EDR; or (iii) BLE or BR/EDR.

Consider first the case in which device 102 is configured to transmit the data messages using BLE. In this case the data messages may be communicated at a bitrate of 1 Mbps, or 2 Mbps.

The data messages may be communicated over a data channel defined by BLE. This data channel may refer to one of the 37 dedicated RF data channels specified by BLE, or to the sequence of such RF channels specified by the established frequency hopping pattern. The device may be configured to increase its transmission power to 20 dBm once a data connection has been established. The device may do this because once a data connection has been established over a frequency hopping pattern that hops over more than 15 channels, it may be classified as frequency hopping equipment and so no longer be subject to the regulatory requirements specified for non-frequency-hopping equipment (e.g. the spectral density limit of 10 mW/MHz imposed on DSSS devices by the ETSI, which limits BLE devices to 10 dBm when transmitting at a rate of 1 Mbps and 13 dBm when transmitting at 2 Mbps). Thus the device may be configured to increase its transmission power for transmitting data messages in response to establishing a connection that uses a number of frequency hopping channels greater than fifteen.

Considering now the example in which the device is configured to transmit the data messages using BR/EDR, the device 102 could establish the connection using BLR and then switch to BR/EDR. The device may be configured to switch from the BLR to BR/EDR in response to detecting that a connection has been established from the advertising messages. In other words, a device may be configured to use BLR to establish a connection and then switch to BR/EDR without requiring the a priori establishment of a BR/EDR connection.

In the event the data messages are communicated according to BR/EDR, the data channel over which the data messages are communicated may be the basic piconet or adapted piconet physical channels. The data messages communicated according to BR/EDR may be related to the logical transports on which they are used. The data messages may for example comprise SCO or eSCO packets. Alternatively they may comprise ACL packets. The raw bitrate for the data messages communicated according to BR may be 1 Mbps; for data messages communicated according to EDR the raw bitrate may be 2 Mbps, or 3 Mbps. Thus again device 102 could establish a connection using BLR whilst staying below the 10 dBm power limit and increase its range, and then switch to ‘Classical’ Bluetooth to increase the transmission power for data transfer. Once communicating according to Classical Bluetooth, the device may no longer be constrained to limit its transmission power density. Thus the device may communicate the data messages according to BR/EDR with a power spectral density greater than 10 mW/MHz, for example. It may also increase its transmission power to above 10 dBm because BR/EDR does not impose a 10 dBm transmission power limit. The transmission power may be increased to 20 dbm, for example.

In one example implementation, devices 102 and 104 may be a smartphone and Bluetooth headset respectively. The Bluetooth radio of the smartphone may be in standby state when the phone receives an incoming call. In response, the Bluetooth radio is switched from standby state to advertising state and initiates a BLR connection with the headset. Once the connection has been established, the smartphone causes the Bluetooth radio to switch to communicating data messages according to BR/EDR. This would advantageously enable a user wearing the headset but not carrying his phone to still be able to receive calls.

In another example implementation, a device may communicate messages according to BLR to establish a connection with another device and to discover non-Bluetooth services supported by that device. To discover these services, the device may communicate service discovery request messages. These messages may be communicated at the BLR data rate of 125 kbps or 500 kbps. Communicating these messages at the BLR data rate advantageously allows the range of these messages to be extended compared to using the conventional BLE data rate of 1 Mbps (or 2 Mbps) for similar reasons to that described above. Thus a device could extend the range over which it can discover non-Bluetooth services by communicating the service request messages using BLR.

The methods described herein may enable BLE devices to increase their range over advertising channels when trying to establish a connection whilst maintaining their transmission power below a level required for worldwide regulatory compliance. Thus devices may benefit from increased range without manufacturers and/or vendors having to maintain regional-based regulatory requirements; a single specification device can be produced that satisfies each jurisdictional power regulation. This may mean that a device can simply operate its Bluetooth radio regardless of the location of the device without first having to determine its location and then configure its radio accordingly.

The above-described examples describe how a device can establish and communicate data messages over a wireless communication connection with another device. It will be appreciated that the device may establish connections with a plurality of other devices. For example, device 102 may establish connections with devices 104 and 106. The device may use different Bluetooth protocols to communicate with the different devices with which it has established a connection. For example, device 102 may establish a connection with devices 104 and 106 using BLR, and then communicate data messages to device 104 using BLE and communicate data messages to device 106 using BR/EDR. The protocol layers and packet structures described herein are not to be taken as limiting the protocol layers required by the device and the data packets communicated therefrom, but rather are intended to serve as an illustration as the types of data packets that may be communicated from the device and the protocol layers it may be running.

As used herein, the maximum bitrate and/or maximum data rate may refer to a peak value or a time averaged value. Similarly, the transmission power levels and power densities described herein may refer to peak values or time-averaged values. It will be appreciated that the numerical values of the bitrates described herein may not be exact but may encompass deviations (e.g. ±20 ppm) that are expected when implemented in a real-world device running a clock.

Although the devices have been shown and described as comprising a number of discrete blocks, it will be appreciated that these blocks may be combined into a single functional block and/or embedded as part of a single integrated circuit, or chip.

In the examples above, the devices are described as supporting multiple Bluetooth technologies. The principles described above are also applicable to devices that support other technologies. A first device may support two technologies that share features such as the frequency band in which the device operates when using the respective technology (e.g. the 2.4 GHz band) and/or the mode of operation of the network to which the device forms part of when using the respective technology (e.g. the networks for both technologies may be ad hoc, or infrastructured), but that differ in other aspects such as the maximum power level that the device is configured to be capable of using in respect of each technology and/or the maximum data rate that the device is configured to be capable of using in respect of each technology and/or the maximum range that the device is configured to be capable of communicating messages over in respect of each technology. Each technology may support the transmission of advertising messages for use in establishing a connection between devices. An advertising message may be a data transmission that includes an address of a transmitting device. A first device may be configured to, on receiving a message of a predetermined format from a second device which addresses the first device by the address included in an advertising message transmitted by the first device, undergo a process of establishing a traffic data connection with the second device. The first device may be configured to transmit the advertising message on one or more physical or logical channels that are not used during the traffic data connection. The channels may be separated in frequency.

The first device may be configured to transmit an advertising message by means of a first one of the technologies it supports, and establish a data connection with a second device according to either of the technologies it supports by means of the data contained in the advertising message. The first device may be configured to automatically propose or accept that the data connection will be according to the second technology in response to one or more predetermined criteria. Those criteria may include any of: a minimum preferred or required data rate; a maximum desired or required channel occupancy time or a minimum transmission power level. The technologies could be, for example, Wi-Fi defined by the IEEE 802.11 protocol, Zig-Bee defined by the IEEE 802.15.4 protocol or a body area network (BAN) technology defined by the IEEE 802.15.6 protocol.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the example embodiments may consist of any such individual feature or combination of features. In view of the foregoing description it will be evident to a person skilled in the art that various modifications may be made within the scope of the disclosure.

1. A method of operating a wireless device, the method comprising:
transmitting an advertising message to a target device using a first wireless technology;
establishing a data session with the target device based on the advertising message transmitted using the first wireless technology; and
transmitting one or more data messages to the target device during the data session established based on the advertising message and using a second wireless technology that provides higher bitrates than the first wireless technology, wherein the first wireless technology and the second wireless technology are Bluetooth technologies.

2. (canceled)

3. The method of claim 1, wherein the first wireless technology provides a maximum bitrate of less than 1 Mbps.

4. The method of claim 1, wherein the second wireless technology provides a maximum bitrate greater than 1 Mbps.

5. The method of claim 1, wherein the second wireless technology provides higher transmission power levels than the first wireless technology.

6. The method of claim 1, wherein the first wireless technology is a Bluetooth Long Range technology.

7. The method of claim 6, wherein the second wireless technology is one from the group consisting of a Bluetooth Low Energy (BLE) technology and a Bluetooth basic rate (BR)/enhanced data rate (EDR) technology.

8. The method of claim 1, wherein the second wireless technology provides at least twice a maximum bitrate of the first wireless technology.

9. The method of claim 1, wherein a maximum bitrate of the first wireless technology is 500 kbps.

10. The method of claim 1, wherein a maximum bitrate of the second wireless technology is one from the group consisting of: 1 Mbps, 2 Mbps and 3 Mbps.

11. The method of claim 1, wherein the advertising message is transmitted at a bitrate of one from the group consisting of 500 kbps and 125 kbps.

12. The method of claim 1, wherein the one or more data messages are transmitted at a maximum bitrate of the second wireless technology.

13. The method of claim 1, wherein the advertising message is transmitted at a power spectral density of less than 10 mW/MHz and the one or more data messages are transmitted at a power spectral density greater than or equal to 10 mW/MHz.

14. The method of claim 1, wherein the advertising message is transmitted at a transmission power level less than or equal to 10 dBm and the one or more data messages are transmitted at a transmission power level greater than 10 dBm.

15. The method of claim 1, wherein the advertising message includes a device identifier (ID) for the wireless device and a payload indicating an ability to support the wireless connection.

16. The method of claim 1, wherein the advertising message initiates a wireless connection exchange with the target device to establish the wireless connection.

17. The method of claim 16, wherein the one or more data messages are transmitted in accordance with a frequency hopping pattern negotiated during the wireless connection exchange.

18. The method of claim 1, wherein the advertising message is transmitted via an advertising channel associated with the first wireless technology and the one or more data messages are transmitted via a data channel associated with the second wireless technology.

19. The method of claim 1, wherein the one or more data messages are transmitted at a bitrate greater than a maximum bitrate of the first wireless technology.

20. A wireless device, comprising:
one or more processors; and
a memory storing instructions that, when executed by the one or more processors, cause the wireless device to:
transmit an advertising message to a target device using a first wireless technology;
establish a data session with the target device based on the advertising message transmitted using the first wireless technology; and
transmit one or more data messages to the target device during the data session established based on the advertising message and using a second wireless technology that provides higher bitrates than the first wireless technology, wherein the first wireless technology and the second wireless technology are Bluetooth technologies.

21. A non-transitory computer readable medium storing instructions that, when executed by one or more processors of a wireless device, cause the wireless device to:
transmit an advertising message to a target device using a first wireless technology;
establish a data session with the target device based on the advertising message transmitted using the first wireless technology; and
transmit one or more data messages to the target device during the data session established based on the advertising message and using a second wireless technology that provides higher bitrates than the first wireless technology, wherein the first wireless technology and the second wireless technology are Bluetooth technologies.
